(19) United States
(12) Patent Application Publication
(10) Pub. No.: US 2010/0237811 A1
(43) Pub. Date: Sep. 23, 2010

(54) Six-Phase Firing Circuit For Brushless DC Controls

(75) Inventor: Wesley McKinley Luckadoo, Charlotte, NC (US)

Correspondence Address: Wesley McKinley Luckadoo, 2035 Knickerbocker Drive, Charlotte, NC, 28212, US

(73) Assignee: Wesley McKinley Luckadoo, Charlotte, NC (US)

(21) Appl. No.: 12/713,224

(22) Filed: Feb. 26, 2010

Related U.S. Application Data
(60) Provisional application No. 61/210,445, filed on Mar. 19, 2009.

(51) Int. Cl. H02P 6/14; H02P 6/16

(52) U.S. Cl. 318/400.13; 318/400.27

(57) ABSTRACT

A six-phase 12 step firing circuit for brushless DC controllers to independently distribute current in six motor stator windings of a six-phase brushless DC motor, the firing circuit receives hall sensor rotor position signals in conjunction with a drive start signal and pulse width modulation commands driving a six-phase power bridge assembly fired at 30 degree intervals to produce a sequence for rotation of the motor.

### CROSS REFERENCE TO RELATED APPLICATION

This application claims the benefit of Provisional Patent Application No. 61/210,445 which was filed on Mar. 19, 2009 by the present inventor.

### BACKGROUND OF THE INVENTION

1. Field of the Invention

The present invention relates to brushless motor controls, more specifically a firing circuit method for distributing current independently to the six stator windings of a brushless DC motor.

2. Description of the Related Art

Brushless DC systems today are more efficient, better speed/torque characteristics, higher response and speed ranges, plus they operate more quietly compared to conventional DC systems and AC inverters. In three-phase brushless DC systems of today two windings are excited at a time to create a rotating electrical field.

Comparing six-phase brushless DC controllers to three-phase brushless DC controllers, in a six-phase design the motor is wired in a split 2 wye or split 2 delta for six independently wired stator windings which four windings are excited at a time to create a rotating electrical field. The currents in each winding are half of the prior art plus distributes the motor torque more evenly for a smoother operation. Attributes of this present art are smaller line and motor wires, smaller start-up and stall currents, less demand on the power grid, better speed/torque characteristics, better response, improve positioning, quieter operation, reduced torque ripple, and higher system reliability. This present distribution of motor current will deliver a more even ratio of torque to the motor helping in applications where weight and space are critical factors.

U.S. Pat. No. 4,758,768 discloses a 12 step commutation device for an electric motor. The device is designed to reduce torque ripple and increase motor efficiency in a three phase brushless DC motor by adding 6 additional commutation steps occurring between each of the original 6 steps using additional hall-effect sensors. The prior art uses a three-phase brushless DC motor and a three-phase power bridge.

U.S. Pat. No. 6,956,341 discloses two inverters (INV1, INV2) supply phase currents to three-phase coils (Y1, Y2). This system is used to reduce the number of phase currents to be measured as a result of an observer for phase current estimation. This prior art does not mention a six-phase firing circuit for brushless DC controls.

Both of these prior arts does not disclose reduction of motor current by 50%, a six-phase firing circuit receiving hall sensor feedback signals for positioning control or connected to a 6-phase power bridge assembly comprising of a six-phase brushless DC motor firing at 30 electrical degrees for a 360 degree electrical cycle.

### BRIEF SUMMARY OF INVENTION

It is the object of the present invention to independently distribute current in the six windings of a six-phase brushless DC motor every 30 electrical degrees, and thereby reducing the motor current in half of the prior art. This will help in large horse power systems, low voltage applications and battery source applications by the reduction of motor currents for the same given horse power. To achieve this object, one embodiment of the present invention is a six-phase power bridge assembly comprising of twelve power switching devices connected to a six-phase brushless DC motor.

A second embodiment of the present invention is coupled to the hall sensor inputs from the motor to provide rotor position signals to a analog switch to sequence six-phase power bridge assembly switching devices Q1-Q2-Q3-Q4-Q5-Q6.

A third embodiment of the present invention provides a comparator circuit coupled to the hall effect sensors inputs to reset the decade counter and provide input frequency to a phase lock loop. The decade counter and the phase lock loop will provide a clock signal to a flip-flop to deliver the rotor position signals for a second analog switch to sequence six-phase power bridge assembly switching devices Q7-Q8-Q9-Q10-Q11-Q12.

### BRIEF DESCRIPTION OF DRAWINGS

FIG. 1 is a schematic diagram of a six-phase power bridge assembly. The diagram comprises of the + and − DC buss bars with twelve power switching devices wired to the six-phase brushless DC motor windings connected in a split two wye.

FIG. 2 is a schematic diagram of a six-phase 12 step firing circuit. It comprises of an analog switch and or gates to sequence six-phase power bridge assembly switching devices Q1-Q2-Q3-Q4-Q5-Q6. A comparator, decade counter, phase lock loop, flip-flop, analog switch and or gates to sequence six-phase power bridge assembly switching devices Q7-Q8-Q9-Q10-Q11-Q12.

FIG. 3 is a timing graph showing the majors waveforms for a 360 electrical degree cycle.

### DETAILED DESCRIPTION OF INVENTION

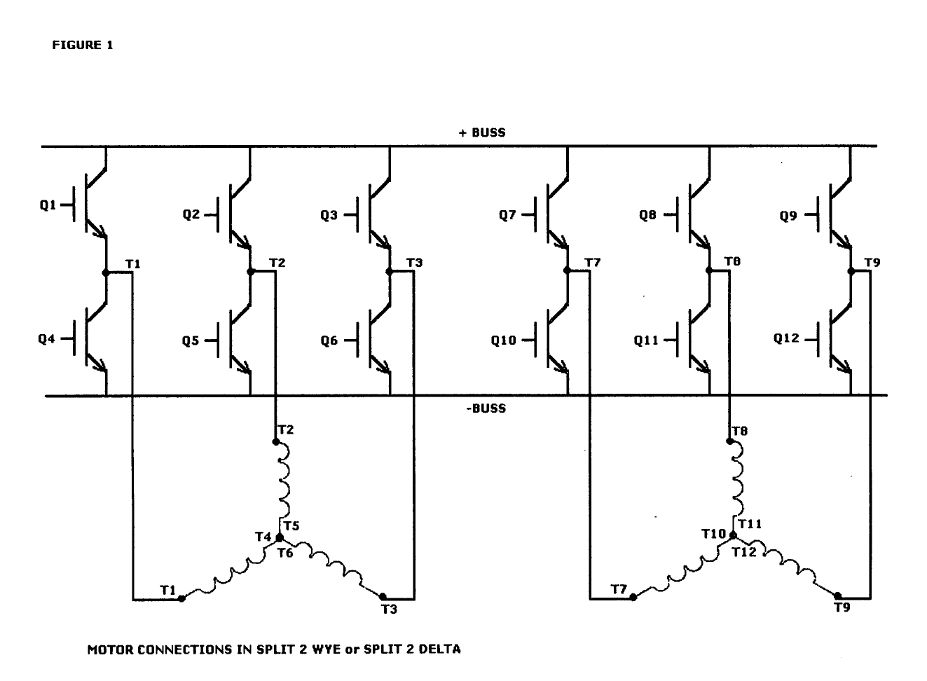

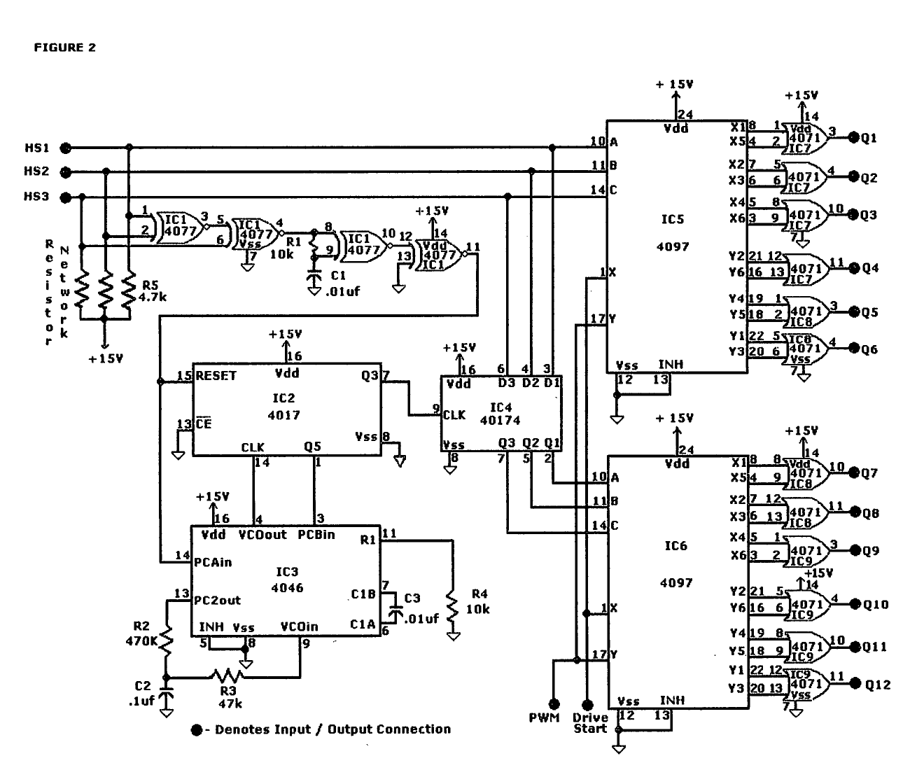

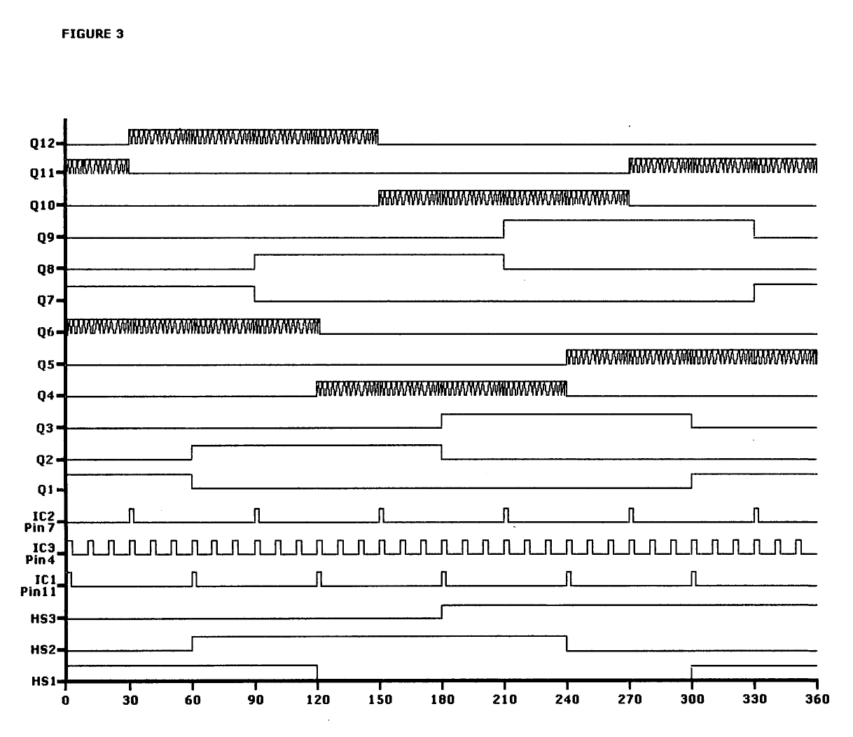

Refer to FIG. 1, FIG. 2, FIG. 3 and TABLE 1 for the full explanation of the Detailed Description. TABLE 1 is located below.

The signal input X of IC5 and IC6 is a +15 volt drive start signal for activation of top six-phase power bridge switching devices Q1-Q2-Q3-Q7-Q8-Q9.

The signal input Y of IC5 and IC6 are interfaced to the pulse width modulation signal for activation of bottom six-phase power bridge switching devices Q4-Q5-Q6-Q10-Q11-Q12.

The sequencing inputs of analog switches IC5 and IC6 are weighted with A=1, B=2, and C=4 to produce motor rotation. The hall sensor voltage is supplied from resistor network R5 and interfaced to analog switch IC5 to sequence six-phase power bridge switches Q1-Q2-Q3-Q4-Q5-Q6 for steps 1, 3, 5, 7, 9, and 11. These steps will transition at degrees 0-60-120-180-240-300.

The exclusive nor gate IC1 will trigger on hall sensor transitions. The hall sensors provide a rotor position signal transition every 60 electrical degrees at degrees 0-60-120-180-240-300 that will reset the decade counter IC2 plus provide a frequency input to the phase lock loop IC3.

The phase lock loop IC3 will clock the decade counter IC2 six times before the decade counter Q5 provides a signal to the phase detector of IC3. The output of the phase detector is a voltage that represents the error between the rotor position signal and the phase of the divided down by 6 voltage-control oscillator signal. This error signal is filtered with R2, R3 and C2 then used to control the frequency of the voltage-controlled oscillator forcing it to track the rotor position signals. The center frequency range of the voltage-controlled oscillator is set by C3, the maximum frequency is set by R4. Q3 output of the decade counter IC2 will clock the flip-flop IC4 and the rotor position signals will transfer from the flip-flop IC4 to the analog switch IC6 to sequence six-phase power bridge switching devices Q7-Q8-Q9-Q10-Q11-Q12 for steps 2, 4, 6, 8, 10, and 12. These steps will transition at degrees 30-90-150-210-270-330.

TABLE 1
Power Bridge Sequencing Steps for Motor Rotation

| Step | Electrical Degrees | Power Bridge Switches |
|---|---|---|
| 1 | 0 | 1-6 |
| 2 | 30 | 7-12 |
| 3 | 60 | 2-6 |
| 4 | 90 | 8-12 |
| 5 | 120 | 2-4 |
| 6 | 150 | 8-10 |
| 7 | 180 | 3-4 |
| 8 | 210 | 9-10 |
| 9 | 240 | 3-5 |
| 10 | 270 | 9-11 |
| 11 | 300 | 1-5 |
| 12 | 330 | 7-11 |

Using FIG. 3, HS1, HS2 and HS3 are hall sensor signals from the motor. Each step preformed below, can also be verified using FIG. 2 and FIG. 3.

With the rotor at 0 electrical degrees, HS1 is high, HS2 is low and HS3 has transitioned from high to low. This halitensor value of one applied to the sequence inputs of analog switch IC5 will select channel X1 to drive or gate IC7 output for operation of six-phase power bridge switching device Q1 and select channel Y1 to drive or gate IC8 output for operation of six-phase power bridge switching device Q6 (step1).

With the rotor at 30 electrical degrees, Q3 of the decade counter IC2 will clock flip-flop IC4 and transfer a hall sensor value of one to the sequence inputs of analog switch IC6. This will select channel X1 to drive or gate IC8 output for operation of six-phase power bridge switching device Q7 and select channel rt to drive or gate IC9 output for operation of six-phase power bridge switching device Q12 (step 2).

With the rotor at 60 electrical degrees, HS1 is high, HS2 will transition from low to high applying a hall sensor value of three to the sequence inputs of analog switch IC5. This will select channel X3 to drive or gate 107 output for operation of six-phase power bridge switching device Q2 and select channel Y3 to drive or gate IC8 output for operation of six-phase power bridge switching device Q6 (step 3).

With the rotor at 90 electrical degrees, Q3 of the decade counter IC2 will clock flip-flop IC4 and transfer hall sensor value of three to the sequence inputs of analog switch IC6. This will select channel X3 to drive or gate IC8 output for operation of six-phase power bridge switching device Q8 and select channel Y3 to drive or gate IC9 output for operation of six-phase power bridge switching device Q12 (step 4).

With the rotor at 120 electrical degrees, HS1 will transition low and HS2 is high applying a hall sensor value of two to the sequence inputs of analog switch IC5. This will select channel X2 to drive or gate IC7 output for operation of six-phase power bridge switching device Q2 and select channel Y2 to drive or gate IC7 output for operation of six-phase power bridge switching device Q4 (step 5).

With the rotor at 150 electrical degrees, Q3 of the decade counter IC2 will clock flip-flop IC44 and transfer hall sensor value of two to the sequence inputs of analog switch IC6. This will select channel X2 to drive or gate IC8 output for operation of six-phase power bridge switching device Q8 and select channel Y2 to drive or gate IC9 output for operation of six-phase power bridge switching device Q10 (step 6).

With the rotor at 180 electrical degrees, HS2 is high and HS3 will transition high applying a hall sensor value of six to the sequence inputs of analog switch IC5. This will select channel X6 to drive or gate IC7 output for operation of six-phase power bridge switching device Q3 and select channel Y6 to drive or gate IC7 output for operation of six-phase power bridge switching device Q4 (step 7).

With the rotor at 210 electrical degrees, Q3 of the decade counter IC2 will clock flip-flop IC4 and transfer hall sensor value of six to the sequence inputs of analog switch IC6. This will select channel X6 to drive or gate IC9 output for operation of six-phase power bridge switching device Q9 and select channel Y6 to drive or gate IC9 output for operation of six-phase power bridge switching device Q10 (step 8).

With the rotor at 240 electrical degrees, HS2 will transition low and HS3 is high applying a hall sensor value of four to the sequence inputs of analog switch IC5. This will select channel X4 to drive or gate IC7 output for operation of six-phase power bridge switching device Q3 and select channel Y4 to drive or gate to IC8 output for operation of six-phase power bridge switching device Q5 (step 9).

With the rotor at 270 electrical degrees, Q3 of the decade counter IC2 will clock flip-flop IC4 and transfer hall sensor value of four to the sequence inputs of analog switch IC6. This will select channel X4 to drive or gate IC9 output for operation of six-phase power bridge switching device Q9 and select channel Y4 to drive or gate IC9 output for operation of six-phase power bridge switching device Q11 (step 10).

With the rotor at 300 electrical degrees, HS1 will transition high and HS3 is high applying a hall sensor value of five to the sequence inputs of analog switch 105. This will select channel X5 to drive or gate 107 output for operation of six-phase power bridge switching device Q1 and select channel Y5 to drive or gate IC8 output for operation of six-phase power bridge switching device Q5 (step 11).

With the rotor at 330 electrical degrees, Q3 of the decade counter IC2 will clock flip-flop IC4 and transfer hall sensor value of five to the sequence inputs of analog switch IC6. This will select channel X5 to drive or gate 108 output for operation of six-phase power bridge switching device Q7 and select channel Y5 to drive or gate IC9 output for operation of six-phase power bridge switching device Q11 (step 12).

This present art is designed for pulse width modulation input to the firing circuit. Simply modifications can be made to the firing circuit to accept sinusoidal wave forms for motor rotation.

This present art can be easily modified for 12-phase 24 step operations and 24-phase 48 step operations.

It will be appreciated and apparent by those skilled in the art that changes, modifications, variations and substitutions of the invention may be made without departing from the inventive concepts and principles in performing the same functions in the aforementioned descriptions and drawings. It is not intended that the invention is limited in nature to the illustrative embodiment described herein. It is intended that all such changes, modifications, variations and substitutions be included within the scope of the invention defined by the appended claims and their equivalents. Special needs are intended to accommodate all horsepower ranges, motor positioning feedback systems and power bridge assembly devices.

I claim:

1. A firing circuit for brushless DC controls to operate a multi-phase brushless DC motor, which said firing circuit comprising of: sequencing devices to drive a multi-phase power bridge assembly connected to said motor, currents are independently distributed to motor stator windings firing at thirty electrical degrees intervals in a sequence for rotation of the rotor.

2. The firing circuit in accordance with claim 1, wherein the said motor has six windings displaced 60 degrees from one another.

3. The firing circuit in accordance with claim 1, said multi-phase motor comprising of: two independently wired three-phase stator windings.

4. The firing circuit in accordance with claim 1, wherein the said sequencing devices receives pulse width modulation signals and drive start signal to provide switching voltages to said multi-phase power bridge assemblies switching devices.

5. The firing circuit in accordance with claim 1, wherein the said motor has rotor position signals directly interfaced to one sequencing device that produces firing sequences to the multi-phase power bridge assemblies switching devices for the first set of independently wired three-phase motor stator windings producing rotation of the rotor.

6. The firing circuit in accordance with claim 1, wherein the said motor has rotor position signals indirectly interfaced to second sequencing device.

7. The firing circuit in accordance with claim 5, wherein the rotor position signals provides a transition signal to a comparator which resets a decade counter and provides a frequency input to a phase lock loop, the phase lock loop will clock a decade counter six times every sixty electrical degrees of rotation, the decade counter will provide an input frequency to the phase detector of the phase lock loop every six clock signals, the output of the phase detector is an error between the rotor position signal and the divided down voltage control oscillator signal, then used to control the frequency of the voltage controlled oscillator that is forced to track the rotor position signals.

8. The firing circuit in accordance with claim 6, wherein the third count of the decade counter is used to clock a flip-flop, which applies the rotor position signals to the second sequencing device that produces firing sequences to the multi-phase power bridge assemblies switching devices for the second set of independently wired three-phase motor stator windings producing rotation of the rotor.
